(19) United States
(12) Patent Application Publication
(10) Pub. No.: US 2010/0133031 A1
(43) Pub. Date: Jun. 3, 2010

(54) HYDRAULIC HYBRID POWER SYSTEM

(76) Inventor: Edward Charles Mendler, Mill Valley, CA (US)

Correspondence Address: Charles Mendler, 7 Millside lane, Mill Valley, CA, 94941, US

(21) Appl. No.: 12/451,690

(22) PCT Filed: May 15, 2008
(86) PCT No.: PCT/US2008/006307

§ 371 Date: Nov. 24, 2009

Related U.S. Application Data
(60) Provisional application No. 60/931,965, filed on May 24, 2007.

(51) Int. Cl. B60K 6/12

(52) U.S. Cl. 180/165

(57) ABSTRACT

According to the present invention a pump is driven by one or more wheels of a hydraulic hybrid vehicle during braking. The inertial energy of the vehicle powers the pump during braking of the vehicle, and the pump pumps a hydraulic liquid into an hydraulic accumulator that stores the fluid at its elevated pressure. When additional power is required by the vehicle, the liquid is released into a heat exchanger that transfers heat from the exhaust gas of the engine to the liquid causing at least a portion of the liquid to become gaseous. The heated fluid is then fed into an expander that generates shaft power by expanding the pressurized and heated gaseous and/or liquid fluid mixture. The preferred embodiment of the present invention operates under the Rankine cycle or steam engine cycle where the liquid compression function is performed using power from regenerative braking, and the liquid heating and vaporization function is performed using exhaust gas waste heat. The present invention shows potential for more than tripling the regenerative braking power of hydraulic hybrid vehicles, thereby providing a large improvement in vehicle fuel economy.

This application relates to Provisional Application 60/931,965 having a filing date of May 24, 2007.

### BACKGROUND OF THE INVENTION

Hydraulic hybrid drive systems for improving vehicle fuel economy have been known for some time. These hydraulic hybrid systems capture energy normally wasted during braking and re-use the same energy to accelerate the vehicle at a later time, thereby reducing fuel consumption. Hydraulic hybrid vehicles typically include a pump that is driven by one or more of the vehicles wheels during braking. During braking the pump pumps a liquid hydraulic fluid into a hydraulic accumulator. The hydraulic accumulator is typically partially filled with nitrogen, the nitrogen being held separate from the liquid hydraulic fluid by a bladder or other separation means. The nitrogen acts as a spring. During braking the pump compresses the nitrogen spring by pumping liquid hydraulic fluid into the hydraulic accumulator. At a later time when power is required for accelerating or propelling the vehicle, the pressurized liquid hydraulic fluid is released from the hydraulic accumulator to drive a motor. Frequently the pump is run backwards to provide the function of both pump and motor. These pump/motors can be less expensive than having two separate machines. Typically the motor is coupled to the vehicle's drive wheels for providing motive power for the vehicle. Using the energy captured during braking for acceleration at a later time results in an improvement in vehicle fuel economy. One such system is described in detail in U.S. Pat. No. 6,719,080 issued Apr. 13, 2004 to Charles L. Gray, Jr. of and assigned to the U.S. Environmental Protection Agency. The U.S. Environmental Protection Agency has been involved with development and prototyping of hydraulic hybrid vehicles for some time.

Hydraulic hybrid drive systems can improve vehicle fuel economy by 25 to 35% according to a number of organizations, including the Eaton Corporation and the U.S. Army's National Automotive Center. The fuel economy benefit can be larger if a smaller primary internal combustion engine is used, taking into consideration the added power provided by the hydraulic motor.

The fuel economy benefit of these hydraulic hybrid vehicles is strongly dependent on the efficiency of the pump and motor, or pump/motor. Regenerative braking efficiency is approximately equal to the product of pump efficiency times the motor efficiency times the hydraulic line and hydraulic accumulator flow efficiency. For systems having a pump/motor one-way efficiency of approximately 80%, overall efficiency will be less than 64%. In such a system, a little less than ⅔rds of the braking energy is reused for propulsion. An objective of the present invention is to provide a significantly higher efficiency hydraulic power system.

Hydraulic hybrid vehicles generally have lower cost than hybrid electric vehicles. In particular, the hydraulic accumulator used in hydraulic hybrid vehicles is significantly less costly than the electric batteries used in hybrid electric vehicles. The efficiency of hydraulic hybrid vehicles and hybrid electric vehicles is generally similar. Proposals have been made for further increasing the efficiency of hybrid electric vehicles, however these proposals are generally impractical because they add cost to an already expensive system. For example, Shigeru Ibaraki shows a hybrid electric vehicle plus a Rankine bottoming cycle powertrain in U.S. Pat. No. 7,056,251 issued on Jun. 6, 2006. Ibaraki employs an electric generator to capture kinetic energy during vehicle braking, and a separate Rankine cycle engine to capture exhaust gas waste heat. The system is very costly due to the added cost of the Rankine cycle engine to the already costly hybrid electric powertrain.

Accordingly, objectives of the present invention are to provide a significantly higher efficiency hydraulic power system, and a cost lower than current production hybrid electric powertrains.

### SUMMARY OF THE INVENTION

According to the present invention a pump is driven by one or more wheels of a hydraulic hybrid vehicle during braking. The hydraulic hybrid vehicle has a heat engine such as a reciprocating piston internal combustion engine. The inertial energy of the vehicle powers the hydraulic pump during braking of the vehicle, and the pump pumps a liquid into a hydraulic accumulator that stores the fluid at its elevated pressure. When additional power is required by the vehicle, the liquid is released into a heat exchanger that transfers heat from the exhaust gas of the heat engine to the liquid causing at least a portion of the liquid to become gaseous. The heated fluid is then fed into an expander that generates shaft power by expanding the pressurized and heated gaseous and/or liquid fluid mixture. The preferred embodiment of the present invention operates under the Rankine cycle or steam engine cycle where the liquid compression function is performed using power from regenerative braking, and the liquid heating and vaporization function is performed using exhaust gas waste heat. The present invention shows potential for more than tripling the regenerative braking power of hydraulic hybrid vehicles, thereby providing a large improvement in vehicle fuel economy. According to the present invention, upgrading the hydraulic hybrid system to include a Rankine bottoming cycle can be accomplished at a relatively low cost because only a few new components are required.

### BRIEF DESCRIPTION OF THE DRAWINGS

FIG. 1 is intended to schematically illustrate a hydraulic power system according to the present invention.

FIG. 2 is intended to schematically illustrate a hydraulic hybrid vehicle having a hydraulic hybrid power system according to the present invention.

FIG. 3 is similar to FIG. 1, but shows a thermal storage medium according to the present invention.

FIG. 4 schematically illustrates an optional location for the driveline speed control device according to the present invention.

FIG. 5 schematically illustrates another optional location for the driveline speed control device according to the present invention.

FIG. 6 schematically illustrates another optional location for the driveline speed control device according to the present invention.

### DETAILED DESCRIPTION OF THE PREFERRED EMBODIMENTS

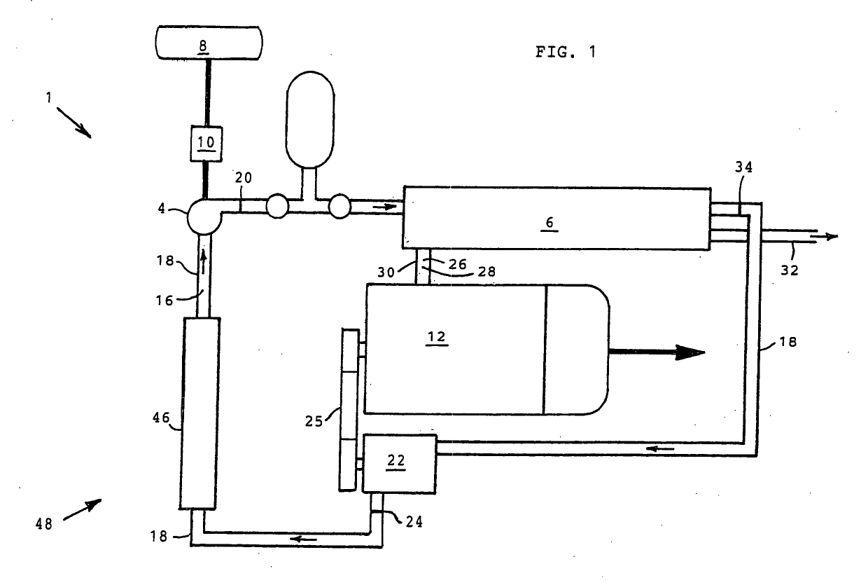

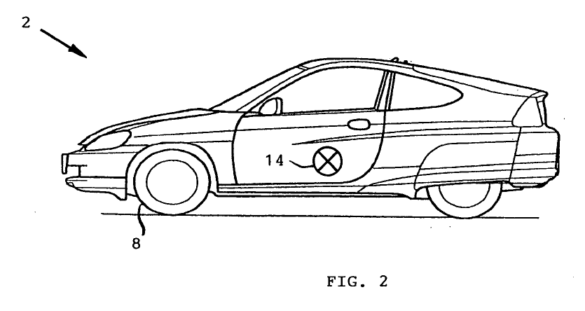

FIGS. 1 and 2 are intended to schematically illustrate a hydraulic power system 1 for a hydraulic hybrid vehicle 2 having a compressor 4 and a heat exchanger 6 according to the present invention.

According to the preferred embodiment of the present invention, compressor 4 is mechanically driven by one or more wheels 8 through an optional coupling 10. Hybrid hydraulic vehicle 2 has an engine 12 and a vehicle inertia or inertial mass 14. Inertial mass 14 is schematically illustrated in FIG. 2

Referring now to FIGS. 1 and 2, hydraulic hybrid vehicle 2 includes a working fluid 16 and hydraulic piping 18 for transporting working fluid 16 through the hydraulic power system. Compressor 4 is positioned and used for pressurizing working fluid 16. Compressor 4 is also rotatably coupled to one or more wheels 8 for converting vehicle inertia 14 into an increase in pressure or an increase in specific internal energy of the working fluid 16 during braking of vehicle 2. Specific internal energy is the internal energy per unit mass of the working fluid. Internal energy typically has units of Joules per gram, or J/gm.

Compressor 4 has a compressor outlet 20 for releasing the compressed working fluid. Working fluid 16 has a first specific volume, the first specific volume being measured at compressor outlet 20. Specific volume is the volume per unit mass of the working fluid. Specific volume typically has units of cubic centimeters per gram, or cc/gm. Specific volume is the reciprocal of density. Working fluid 16 has a first volumetric flow rate, the first volumetric flow rate being measured at compressor outlet 20. Volumetric flow rate is a measure of the volume of flow past a measurement station per unit of time. Volumetric flow rate typically has units of cubic centimeters per second, or cc/s. Working fluid 16 also has a first high pressure state, the first high pressure state being measured at compressor outlet 20. Heat exchanger 6 is located downstream of compressor 4 and downstream of compressor outlet 20.

According to the preferred embodiment of the present invention, hydraulic power system 1 includes an expander or motor 22 for generating shaft power from working fluid 16. Expander or motor 22 may also be referred to as a vapor engine, the vapor engine being capable of expanding a vapor but not compressing a vapor. In general terms, motor 22 is a devise that generates shaft power by expanding and/or reducing the pressure of a fluid, the fluid being in the gaseous state, liquid state, or being a mixture of both gaseous and liquid states. Motor 22 is located downstream of heat exchanger 6. Motor 22 has a motor outlet 24 for releasing working fluid 16. Working fluid 16 has a first low pressure state. The first low pressure state is measured at motor outlet 24. Motor 22 includes means for converting the reduction in pressure of working fluid 16 from the first high pressure state to the first low pressure state into shaft power.

Motor 22 includes drive means 25 for transferring shaft power from motor 22 to engine 12. Drive means 25 may include a chain drive, a gear set, a belt drive, an in-line coupling or other functional means for transmitting shaft power. Drive means 25 may optionally be coupled to one or more wheels (not shown) for transferring shaft power from motor 22 to one or more wheels 8. Motor 22 may optionally be coupled to a generator for generating electricity (not shown).

Engine 12 is preferably a reciprocating piston engine, or other type of internal combustion engine. Engine 12 has exhaust gas 26, and has waste heat 28 contained in exhaust gas 26. Waste heat 28 is also contained in the engine's cooling fluid (not shown). Engine 12 has an upper exhaust pipe 30 and preferably a lower exhaust pipe 32. According to the preferred embodiment of the present invention upper exhaust pipe 30 transfers hot exhaust gas 26 from engine 12 to heat exchanger 6, and heat exchanger 6 transfers waste heat 28 from exhaust gas 26 to working fluid 16.

According to the preferred embodiment of the present invention, hydraulic hybrid vehicle 2 includes heat exchanger 6 for transferring waste heat 28 from the exhaust gas 26 of heat engine 12 to working fluid 16 down stream of compressor 4, for increasing the specific volume and/or increasing the volumetric flow rate of working fluid 16 upstream of motor 22.

Heat exchanger 6 has a heat exchanger outlet 34 for releasing the heated working fluid 16. Working fluid 16 has a second specific volume. The second specific volume is measured at heat exchanger outlet 34. The second specific volume is generally greater than the first specific volume due to heat exchanger 6 adding heat to working fluid 16. Heat exchanger 6 is intended to increase the specific volume of working fluid 16 entering motor 22, to thereby cause motor 22 to generate more power.

Working fluid 16 has a second volumetric flow rate. The second volumetric flow rate is measured at heat exchanger outlet 34. The second volumetric flow rate is generally greater than the first volumetric flow rate due to heat exchanger 6 adding heat to working fluid 16. Heat exchanger 6 is intended to increase the volumetric flow rate of working fluid 16 entering motor 22, to thereby cause motor 22 to generate more power.

According to the preferred embodiment of the present invention, inertial braking energy of vehicle 2 is employed to compress working fluid 16, and heat exchanger 6 is employed to transfer waste heat 28 from the exhaust gas 26 of heat engine 12 to working fluid 16 for increasing the specific volume and also increasing the volumetric flow rate of working fluid 16, thereby providing an increase in shaft power produced by motor 22, and thereby providing the combined vehicle fuel economy benefits of hydraulic regenerative braking and waste heat recovery. The present invention shows potential for more than tripling the regenerative braking power of hydraulic hybrid vehicles.

Pressure, temperature, specific volume and specific flow rate values measured at compressor outlet 20, heat exchanger outlet 34 and motor outlet 24 are general values that vary in magnitude due to variations in the load cycle of the hydraulic power system, and due to heat, friction and pressure losses present in the hydraulic circuit. The present invention is described in general terms taking into consideration the above mentioned variations of fluid state qualities.

Preferably, according to the present invention, waste heat 28 is the waste heat contained in exhaust gas 26 of engine 12. Optionally, waste heat 28 may be provided by the cooling fluid of the engine. Preferably engine 12 is a reciprocating piston internal combustion engine. Optionally, engine 12 may be a different type of combustion engine such as a rotary engine or gas turbine engine.

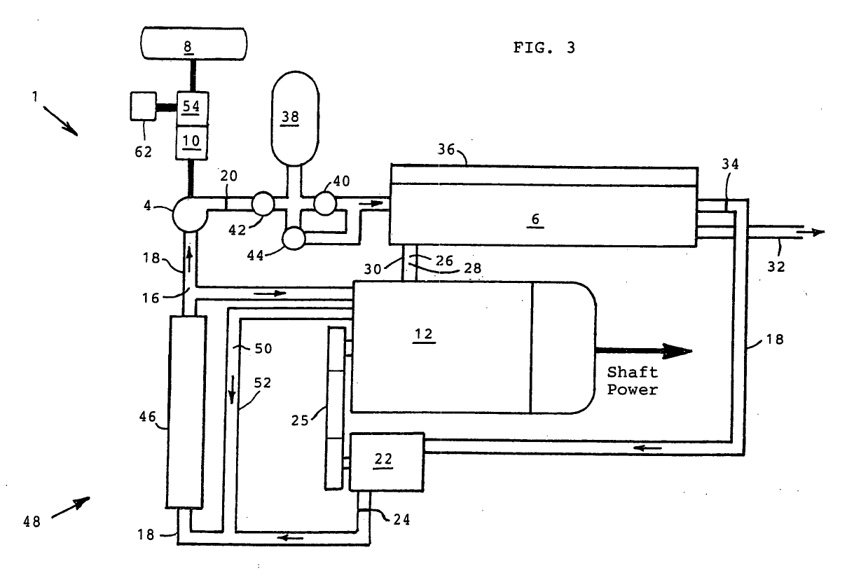

FIG. 3 is similar to FIG. 1, but shows a thermal storage medium 36. Thermal storage medium 36 retains waste heat 28 thereby permitting control of the timing of the transfer of waste heat 28 to working fluid 16 through heat exchanger 6.

Compressor 4 has a compressor rotational speed and motor 22 has a motor rotational speed. According to the present invention, the compressor rotational speed is independent of the motor rotational speed.

Preferably, according to the present invention, compressor 4 is disengaged, not pumping and/or not substantively pumping working fluid 16 during periods of time when motor 22 is generating shaft power. The compressor performance settings described in the previous sentence are referred to generally as being substantively disengaged. Preferably, according to the present invention, motor 22 is disengaged, not generating shaft power and/or not substantively generating shaft power when compressor 4 is actively pumping working fluid 16. Preferably, according to the present invention, motor 22 has a first shaft power generation setting, and compressor 2 is substantively disengaged at the first shaft power generation setting.

Preferably, according to the present invention, heat exchanger 6 and/or thermal storage medium 36 is not substantively transferring heat to working fluid 16 when compressor 4 is actively pumping and motor 22 is generating no or not a substantive amount of power. Heating working fluid 16 in heat exchanger 6 that is stationary or moving slowly is generally not considered a substantive amount of heat transfer from heat exchanger 6 and/or thermal storage medium 36 to working fluid 16.

According to the present invention, hydraulic hybrid vehicle 2 has a first vehicle operational setting during vehicle braking and a second vehicle operational setting during vehicle acceleration. Working fluid 16 has a first mass flow rate, the first mass flow rate being measured at compressor outlet 20 during vehicle braking. Working fluid 16 has a second mass flow rate, the second mass flow rate being measured at compressor outlet 20 during vehicle acceleration. Working fluid 16 has a third mass flow rate, the third mass flow rate being measured at motor outlet 24 during vehicle braking. Working fluid 16 has a fourth mass flow rate, the fourth mass flow rate being measured at motor outlet 24 during vehicle acceleration. According to the present invention, the first mass flow rate is preferably much greater than the third mass flow rate during vehicle braking. According to the present invention, the second mass flow rate is preferably much smaller than the fourth mass flow rate during vehicle acceleration. According to the present invention, hydraulic power system 1 includes means for controlling the mass flow rate through compressor 4 independently of the mass flow rate through motor 22. Mass flow rate is a measure of the mass flow past a measurement station per unit of time. Mass flow rate typically has units of grams per second, or gm/s.

Preferably according to the present invention, working fluid 16 has a first mass flow rate, the first mass flow rate being measured at compressor outlet 20 during vehicle braking. Working fluid 16 has a second mass flow rate, the second mass flow rate being measured at compressor outlet 20 during vehicle acceleration. Working fluid 16 has a third mass flow rate, the third mass flow rate being measured at motor outlet 24 during vehicle braking. Working fluid 16 has a fourth mass flow rate, the fourth mass flow rate being measured at motor outlet 24 during vehicle acceleration. According to the present invention, the first mass flow rate is substantively greater than the third mass flow rate during vehicle braking, and the second mass flow rate is substantively smaller than the fourth mass flow rate during vehicle acceleration.

Thermal storage medium 36 may optionally be a copper alloy, brass, an aluminum alloy or another material having a relatively high conductivity and preferably a relatively high heat capacity. Preferably the added material used for thermal storage is used for further improving the heat transfer rate of heat exchanger 6. In more detail, the material used for thermal storage is preferably used as well for increasing the heat transfer rate and heat transfer efficiency of heat exchanger 6. Aluminum may be used as a thermal storage medium in areas not exposed to very high temperatures. Optionally thermal storage medium 36 may include a material that changes phase when heated by waste heat 28, where energy is stored in the form of latent heat.

Referring now to all of the Figs., preferably a portion of working fluid 16 changes from a liquid state to a gaseous state in heat exchanger 6. Working fluid 16 preferably contains water, and preferably some or all of the water is converted from the liquid state to the gaseous state in heat exchanger 6. Working fluid 16 may optionally include additives to enhance the thermal properties of the working fluid and/or additives that improve the longevity of the compressor and/or motor.

Optionally working fluid 16 may largely or fully remain in a single thermodynamic state in heat exchanger 6. Optionally working fluid 16 may remain in a gaseous state at all times. Optionally working fluid 16 may remain in a liquid state at all times.

Referring now to FIG. 3, hydraulic power system 1 may optionally include an hydraulic accumulator 38 for storing working fluid 16 at an elevated pressure. Hydraulic power system 1 may also optionally include a control valve 40 for controlling release of working fluid 16 to heat exchanger 6. Hydraulic power system 1 may also optionally include a one-way or check valve 42 for preventing back flow of pressurized working flow into compressor 4. Hydraulic power system 1 may also optionally include a pressure relief valve 44 for preventing over pressurization of hydraulic accumulator 38 and/or over pressurization of the hydraulic piping between compressor 4 and heat exchanger 6. According to an embodiment of the present invention, hydraulic power system 1 includes hydraulic accumulator 38 and control valve 40 for controlling the timing of release of working fluid 16 to motor 22. In more detail, the hydraulic hybrid vehicle converts vehicle inertia into an increase in pressure of the working fluid during braking of the vehicle. During braking additional motive power is not needed. According to the present invention, pressurized working fluid 16 from compressor 4 is stored in the hydraulic accumulator for release at a later point in time when additional power is needed. Preferably the pressurized hydraulic fluid is released to heat exchanger 6 when the engine is generating a substantive amount of power and the exhaust gas 26 accordingly contains a substantive amount of waste heat 28 for heating working fluid 16.

According to a less efficient embodiment of the present invention, hydraulic power systems not having an hydraulic accumulator may optionally use power generated by motor 22 to generate electricity and charge a battery during vehicle braking. As mentioned previously, motor 22 may optionally be coupled to a generator for generating electricity.

Hydraulic power system 1 preferably includes a radiator 46 for cooling working fluid 16 after it is released from motor 22.

Referring now to the embodiment of the present invention schematically illustrated in FIG. 3, engine 12 includes an engine cooling system 48 for cooling engine 12, having an engine cooling fluid 50 and radiator hosing 52 for containing engine cooling fluid 50. Optionally cooling system 48 and hydraulic power system 1 share the same hydraulic fluid, where working fluid 16 is engine cooling fluid 50. Optionally, engine cooling fluid 50 is in fluid communication with compressor 4, and working fluid 16 is in fluid communication with engine 12.

Optionally according to the present invention, radiator 46 is a dual purpose radiator, and in more detail radiator 46 may be employed to both cool working fluid 16 and engine cooling fluid 50, it being understood that the working fluid 16 may optionally be engine cooling fluid 50. Radiator 46 generally has a size large enough for cooling engine 12 under extreme ambient temperatures and for sustained high engine power levels. Accordingly, radiator 46 is larger than necessary for normal driving conditions. Under normal driving conditions radiator 46 is generally large enough to provide for cooling of working fluid 16 because the mass flow rate of working fluid 16 is relatively small under normal driving conditions. Optionally, the present invention may include a hydraulic-system-off control system to prevent over heating of radiator 46.

The dual purpose radiator provides a lower cost and a lighter weight for the hydraulic hybrid system of the present invention.

Referring now to all of the Figs., coupling 10 is used for rotatably coupling compressor 4 to one or more wheels 8. In more detail coupling 10 provides a mechanical coupling between compressor 4 and one or more wheels 8.

Optionally, coupling 10 may include a driveline speed control devise 54. Driveline speed control device 54 may be a clutch, a ratchet, or a planetary gear set.

A significant feature of the present invention is that compressor 4 is preferably decoupled from motor 22. According to the present invention, driveline speed control devise 54 is applied to compressor 4 but not applied to motor 22. As mentioned previously, motor 22 may be an expander or a vapor engine not having fluid compression capabilities.

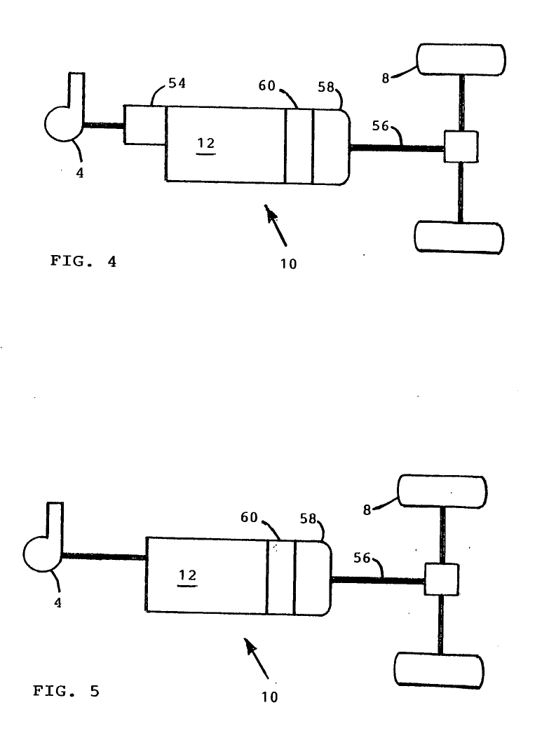

FIG. 3 is intended to illustrate compressor 4 and coupling 10 being separate from engine 12. FIG. 4 shows an embodiment of the present invention where compressor 4 is connected to one or more wheels 8 through engine 12. Engine 12 may optionally include a drive shaft 56, a transmission 58 and a clutch or torque converter 60. In the embodiment of the present invention shown in FIG. 4 pump 4 is coupled to engine 12.

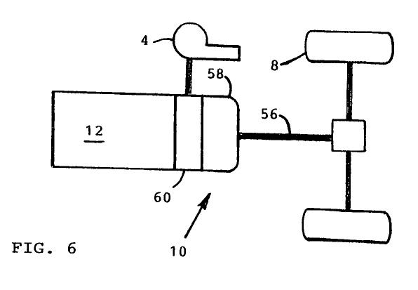

FIG. 5 is similar to FIG. 4, but illustrates clutch 60 performing the function of driveline speed control device 54 to reduce overall cost.

FIG. 6 illustrates another embodiment of the present invention showing compressor 4 driven through transmission 58 but not engine 12. In the embodiment of the present invention shown in FIG. 6 coupling 10 includes transmission 58. Referring now to all of the Figs., preferably motor 22 is coupled to the engine or transmission, thereby providing the benefit to the transmissions gear ratios.

Referring now to FIG. 3, optionally driveline control device 54 may include a clutch that can optionally be engage at times other than during vehicle braking in order to recharge hydraulic accumulator 38 as may be needed from time to time. A second pump may optionally be used to charge the hydraulic accumulator (not shown), the second pump being mechanically driven by the engine or driven by an electric motor, however use of a secondary pump has the draw backs of lower over-all efficiency and cost.

Referring now to FIG. 3, optionally driveline control speed device 54 may include a planetary gear set and an electric machine 62. Electric machine 62 may optionally be a generator, a motor/generator or a motor.

Referring now to all of the Figs., preferably shaft power from motor 22 is used to provide at least a portion of the motive power needed to propel hydraulic hybrid vehicle 2.

According to the present invention, optionally a portion of the shaft power from motor 22 may be used to generate electricity.

The preferred embodiment of the present invention operates under the Rankine cycle or steam engine cycle where the liquid compression function is performed using power from regenerative braking, and the liquid heating and vaporization function is performed using exhaust gas waste heat. The present invention shows potential for more than tripling the regenerative braking power of hydraulic hybrid vehicles, thereby providing a large improvement in vehicle fuel economy. According to the present invention, upgrading the hydraulic hybrid system to include a Rankine bottoming cycle can be accomplished at a relatively low cost because only a few new components are required.

While the invention has been described in terms of preferred embodiments, those skilled in the art will recognize that the invention can be practiced with modifications within the scope of the claims.

1. A hydraulic hybrid vehicle including a heat engine, two or more wheels, a working fluid and a compressor for pressurizing said working fluid, said compressor being rotatably coupled to said one or more wheels for converting vehicle inertia into an increase in pressure of the working fluid during braking of said vehicle,
said compressor having a compressor outlet for releasing the compressed working fluid, said working fluid having a first specific volume, said first specific volume being measured at said compressor outlet, said working fluid having a first high pressure state, said first high pressure state being measured at said compressor outlet,
and a motor for generating shaft power from said working fluid, said motor having a motor outlet for releasing said working fluid, said working fluid having a first low pressure state, said first low pressure state being measured at said motor outlet, wherein said motor includes means for converting the reduction in pressure of said working fluid from said first high pressure state to said first low pressure state into said shaft power,
said heat engine further having waste heat,
wherein, said hydraulic hybrid vehicle further includes a heat exchanger for transferring said waste heat from said heat engine to said working fluid down stream of said compressor, thereby increasing the specific volume of said working fluid, said heat exchanger being located downstream of said compressor and upstream of said motor,
said heat exchanger having a heat exchanger outlet for releasing the heated working fluid, and said working fluid having a second specific volume, said second specific volume being measured at said heat exchanger outlet, said second specific volume generally being larger than said first specific volume due to said heat exchanger, thereby providing an increase in the volumetric flow rate entering the motor thereby providing an increase in shaft power generated by said motor,
wherein inertial braking energy of said vehicle is employed to compress said working fluid, and said heat exchanger is employed to transfer waste heat from said heat engine to said working fluid for increasing the specific volume of said working fluid, thereby providing an increase in shaft power produced by said motor, and thereby providing the combined vehicle fuel economy benefits of hydraulic regenerative braking and waste heat recovery.

2. The hydraulic hybrid vehicle of claim 1, further having a first volumetric flow rate, said first volumetric flow rate being measured at said compressor outlet,
said working fluid having a second volumetric flow rate, said second volumetric flow rate being measured at said heat exchanger outlet, said second volumetric flow rate generally being greater than said first volumetric flow rate due to said heat exchanger, thereby providing an increase in volumetric flow rate entering the motor thereby providing an increase in shaft power generated by said motor,
wherein inertial braking energy of said vehicle is employed to compress said working fluid, and said heat exchanger is employed to transfer waste heat from said heat engine to said working fluid for increasing the volumetric flow rate of said working fluid, thereby providing an increase in shaft power produced by said motor, and thereby providing the combined vehicle fuel economy benefits of hydraulic regenerative braking and waste heat recovery.

3. The hydraulic hybrid vehicle of claim 1, wherein said waste heat is the hot exhaust gas from said heat engine.

4. The hydraulic hybrid vehicle of claim 1, further including a thermal storage medium, wherein said thermal storage medium retains said waste heat thereby permitting control of the timing of the transfer of said waste heat to said working fluid through said heat exchanger.

5. The hydraulic hybrid vehicle of claim 4, wherein said waste heat is the hot exhaust gas from said heat engine, wherein said thermal storage medium is selected from a group including a copper alloy, brass, an aluminum alloy, or a material that changes phase when heated by said hot exhaust gas.

6. The hydraulic hybrid vehicle of claim 1, wherein a portion of said working fluid changes from a liquid state to a gaseous state in said heat exchanger.

7. The hydraulic hybrid vehicle of claim 1, wherein said working fluid largely remains in a gaseous state at all times.

8. The hydraulic hybrid vehicle of claim 1, further including a hydraulic accumulator for control of the timing of release of said working fluid to said motor.

9. The hydraulic hybrid vehicle of claim 1, further having a radiator for cooling the working fluid after it is released from the motor.

10. The hydraulic hybrid vehicle of claim 1, further having an engine cooling fluid for cooling said engine,
wherein said engine cooling fluid and said working fluid are combined, said engine cooling fluid being in fluid communication with said compressor, and said working fluid being in fluid communication with said engine.

11. The hydraulic hybrid vehicle of claim 10, further having a dual purpose radiator, said radiator providing cooling of said engine cooling fluid and said radiator providing cooling of said working fluid.

12. The hydraulic hybrid vehicle of claim 1, wherein said compressor has a compressor rotational speed and said motor has a motor rotational speed,
wherein said compressor rotational speed is independent of said motor rotational speed.

13. The hydraulic hybrid vehicle of claim 1, wherein said motor has a first shaft power generation setting, wherein said compressor is substantively disengaged at said first shaft power generation setting.

14. The hydraulic hybrid vehicle of claim 1, wherein said working fluid has a first mass flow rate, said first mass flow rate being measured at said compressor outlet during vehicle braking,
said working fluid having a second mass flow rate, said second mass flow rate being measured at said compressor outlet during vehicle acceleration,
said working fluid having a third mass flow rate, said third mass flow rate being measured at said motor outlet during vehicle braking,
said working fluid having a fourth mass flow rate, said fourth mass flow rate being measured at motor outlet during vehicle acceleration,
Wherein said first mass flow rate is substantively greater than the third mass flow rate during vehicle braking, and said second mass flow rate is substantively smaller than said fourth mass flow rate during vehicle acceleration.

15. The hydraulic hybrid vehicle of claim 1, further including a coupling for rotatably coupling said compressor to said one or more wheels, wherein said coupling provides a mechanical coupling between said compressor and said one or more wheels.

16. The hydraulic hybrid vehicle of claim 15, further including a driveline disengagement devise selected from the following group: a clutch or a ratchet.

17. The hydraulic hybrid vehicle of claim 1, further including a coupling for rotatably coupling said compressor to said one or more wheels, wherein said coupling includes a planetary gear set and an electric machine.

18. The hydraulic hybrid vehicle of claim 1, wherein said shaft power is used to provide at least a portion of said vehicles motive power.

19. The hydraulic hybrid vehicle of claim 1, wherein at least a portion of said shaft power is used to generate electricity
